(19) United States
(12) Patent Application Publication
(10) Pub. No.: US 2014/0101539 A1
(43) Pub. Date: Apr. 10, 2014

(54) Website presenting method and browser

(71) Applicant: TENCENT TECHNOLOGY (SHENZHEN) COMPANY LIMITED, Shenzhen (CN)

(72) Inventors: Huateng Ma, Shenzhen (CN); Quanzhan Zheng, Shenzhen (CN); Mengqing Wu, Shenzhen (CN); Jinzhou Jiang, Shenzhen (CN); Lin Du, Shenzhen (CN); Ning Zhang, Shenzhen (CN)

(73) Assignee: TENCENT TECHNOLOGY (SHENZHEN) COMPANY LIMITED, Shenzhen (CN)

(21) Appl. No.: 14/042,272

(22) Filed: Sep. 30, 2013

Related U.S. Application Data
(63) Continuation of application No. PCT/CN2012/079516, filed on Aug. 1, 2012.

(30) Foreign Application Priority Data
Aug. 26, 2011 (CN) 2011102476470

(51) Int. Cl. G06F 17/22

(52) U.S. Cl. CPC G06F 17/2247
USPC 715/235

(57) ABSTRACT

An embodiment of the disclosure provides a website presenting method, in which a style attribute of a website to be presented is acquired, a style attribute of a browser is set according to the acquired style attribute of the website; and the browser presents the website according to the set style. Another embodiment of the disclosure discloses a browser. According to the disclosure, the styles of the website and of the browser may be consistent with each other when the website is presented, which results in a good visual effect, and accordingly, a user may gain a more novel and comfortable browsing experience.

### CROSS REFERENCE TO RELATED APPLICATIONS

This is a continuation application of International Patent Application No. PCT/CN2012/079516, filed on Aug. 1, 2012, which claims priority to Chinese Patent Application No. 201110247647.0 filed on Aug. 26, 2011 by the applicant Tencent Technology (Shenzhen) Company Limited and entitled “website presenting method and browser”, the disclosure of which is hereby incorporated by reference herein in its entirety.

### TECHNICAL FIELD

The disclosure relates to network techniques, and in particular to a website presenting method and a browser.

### BACKGROUND

A website is a fixed location on the Internet where messages are published to all over the world, consists of a domain name (also referred to as a website address), a website space and a website source program and generally contains a homepage and other pages with hyperlink files. Common websites include, for example, Qzone. Qzone is developed by Tencent and provides a blogging function, in which a user may keep diaries, upload photos, listen to music, and the like. Generally, a website may provide a style setting function, using which the user may set the style of the website based on his/her preference to meet the appeal in personalization and beautification.

A browser, which is a client browsing program, may send various requests to a World Wide Web (WEB) server and interpret, display and play hypertext information (such as a HyperText Markup Language (HTML) page) and various multimedia data returned by the WEB server. Most of the browsers can provide a style setting function, using which the user may select his/her favorite interface as the presenting style of the browser.

At present, the styles of the website and of the browser are set separately and are independent with each other, and thus the website and the browser are presented in their own styles when the user browses the website with the browser. This may be prone to result in a poor visual effect due to the significant difference between the styles of the website and of the browser, and accordingly, the browsing experience of the user is affected.

### SUMMARY

Embodiments of the disclosure provide a website presenting method and a browser, by which the styles of the website and of the browser may be consistent with each other when the website is presented, which results in a good visual effect, and accordingly, a user may gain a more novel and comfortable browsing experience.

According to one aspect, an embodiment of the disclosure provides a website presenting method, including: acquiring a style attribute of a website to be presented; setting a style attribute of a browser according to the acquired style attribute of the website; and presenting by the browser the website according to the set style attribute.

According to another aspect, an embodiment of the disclosure further provides a browser, including: an acquisition module, configured to acquire a style attribute of a website to be presented; a setting module, configured to set a style attribute of the browser according to the style attribute of the website acquired by the acquisition module; and a presenting module, configured to control the browser to present the website according to the style set by the setting module.

The implementation of the embodiments of the disclosure has the following advantages: in the embodiments of the disclosure, the style attribute of the website to be presented is acquired and the style attribute of the browser is set according to the style attribute of the website, so that the styles of the website and of the browser are consistent with each other. The browser is controlled to present the website according to the set style, such that the consistent styles may result in a good visual effect, and accordingly, the user may gain a more novel and comfortable browsing experience.

### BRIEF DESCRIPTION OF THE DRAWINGS

FIG. 1 is a flow chart of a website presenting method according to an embodiment of the disclosure;

FIG. 2 is a schematic view showing a website presenting effect according to an embodiment of the disclosure;

FIG. 3 is another schematic view showing a website presenting effect according to an embodiment of the disclosure;

FIG. 4 is a flow chart of an embodiment of Step S101 as shown in FIG. 1;

FIG. 5 is a flow chart of another embodiment of Step S101 as shown in FIG. 1;

FIG. 6 is a flow chart of another embodiment of Step S101 as shown in FIG. 1;

FIG. 7 is a flow chart of an embodiment of Step S102 as shown in FIG. 1;

FIG. 8 is a flow chart of another embodiment of Step S102 as shown in FIG. 1;

FIG. 9 is a flow chart of another embodiment of Step S102 as shown in FIG. 1;

FIG. 10 is a diagram showing the structure of a browser according to an embodiment of the disclosure;

FIG. 11 is a diagram showing the structure of an embodiment of the acquisition module as shown in FIG. 10;

FIG. 12 is a diagram showing the structure of another embodiment of the acquisition module as shown in FIG. 10;

FIG. 13 is a diagram showing the structure of another embodiment of the acquisition module as shown in FIG. 10;

FIG. 14 is a diagram showing the structure of an embodiment of the setting module as shown in FIG. 10;

FIG. 15 is a diagram showing the structure of another embodiment of the setting module as shown in FIG. 10;

FIG. 16 is a diagram showing the structure of another embodiment of the setting module as shown in FIG. 10; and

FIG. 17 is a diagram of an exemplary computer platform on which the website presenting method or the browser described in connection with FIGS. 1-16 is implemented.

### DETAILED DESCRIPTION

The embodiments of the disclosure will be described below definitely and thoroughly with reference to the drawings. Apparently, the embodiments described below are provided by way of example, but not by way of limitation. All other embodiments acquired by persons of ordinary skill in the art without any inventive labor in view of the embodiments described below fall within the scope of the disclosure.

According to an embodiment of the disclosure, a browser acquires a style attribute of a website to be presented, sets a style attribute of a browser according to the style attribute of the website, and presents the website according to the set style of the browser.

The style attribute may include the attribute of a page background image, such as the link address, length, width and main color of the page background image. The style attribute may also include the attribute of a page background color, such as the tone and saturation of the page background color. As understood, the style attribute may further include the attribute of each component (such as title and body) on the page, for example, the attribute of a page foreground image (such as the link address, length, width and main color of the page foreground image), the attribute of a page foreground color (such as the tone and saturation of the page foreground color), the attribute of a page font (such as the color and size of the font), and the arrangement of each component on the page.

The process of setting the style attribute of the browser according to the acquired style attribute of the website includes at least one of the following: setting the browser to use a same background image as that of the website, setting the browser to use a similar background image as that of the website, setting the browser to use a same background color as that of the website, setting the browser to use a similar background color as that of the website, setting the style of the browser by setting the main color of the background image of the website as the background tone of the browser, setting the style of the browser by setting the background color of the website as the background tone of the browser, or setting the style of the browser by setting a color similar to the background color of the website as the background tone of the browser, etc. Through the settings above, the styles of the website and of the browser may be consistent with each other, so as to result in a good visual effect in the presenting of the website.

The style of the browser may be controlled through an HTML page, and the control page corresponds to a Cascading Style Sheet (CSS) file, i.e., the control page references its corresponding CSS file path. The style attribute of the browser is defined in the CSS file. If the style of the browser needs to be changed, the CSS file corresponding to the control page may be changed, i.e., the CSS file path currently referenced by the control page may be replaced with one corresponding to a new style. Also, if the style of the browser needs to be changed, the CSS file currently referenced by the control page may be modified directly to one corresponding to the new style. The style of the browser may also be controlled through a C++ control library in the browser. Specifically, the style attribute of the browser may be set by using a control in the C++ control library to control the style attribute of the browser.

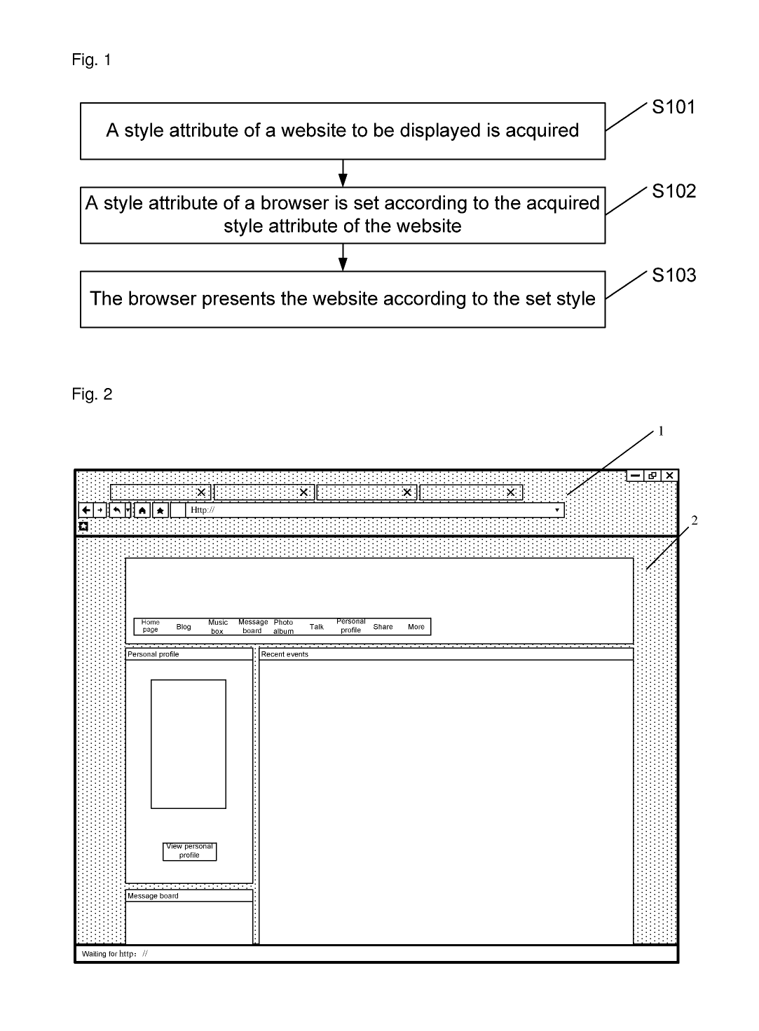

The website presenting method according to an embodiment of the disclosure will be described below in detail with reference to FIGS. 1 to 9.

FIG. 1 is a flow chart of a website presenting method according to an embodiment of the disclosure. Referring to FIG. 1, the method may include:

S101: the style attribute of a website to be presented is acquired.

When a user visits a website with a browser, the style attribute of the website to be presented is acquired in Step S101. The style attribute of the website may be set in the HTML page of the website. In this case, in Step S101, the HTML page may be parsed to acquire the style attribute of the website. The style attribute of the website may also be set in the attribute of the body tag of the HTML page of the website. In this case, in Step S101, the style attribute of the website may be acquired directly from the attribute of the body tag of the HTML page. The body tag is an HTML tag applied in a webpage and represents the body of the webpage. The body tag contains all the labels and attributes to be displayed by the browser and the contents in the body tag may be displayed in the browser. In Step S101, the style attribute of the website may also be acquired from a notification message received from the website. As understood, the style attribute of the website to be presented may further be acquired in other ways in Step S101. For example, the style attribute of the website may be acquired by detecting the Uniform Resource Locator (URL) of the website, detecting the HyperText Transfer Protocol (HTTP) header (which is a character string sent out during the HTTP data transmission), detecting the Cookies of the website (which are data stored in a user local terminal by the website to identify the user for tracking session) or the like.

S102: the style attribute of a browser is set according to the acquired style attribute of the website.

In Step S102, the style attribute of the browser may be set by using a control page or a C++ control library of the browser; in practice, the style attribute of the browser may be set to be the same as or similar to the acquired style attribute of the website in Step S102, wherein an attribute range may be preset for the website as being similar to the style of the website, for example, a color value range may be preset as being similar to the background color of the website; in Step S102, the style attribute of the browser may be set to be similar to the acquired attribute of the website according to the range of similar attributes preset for the website.

S103: the browser presents the website according to the set style.

As the style attribute of the browser set in Step S102 is the same as or similar to that of the website to be presented, the browser presents the website according to the set style in Step S103 so that the styles of the website and of the browser are consistent with each other when the website is presented, so as to result in a good visual effect.

FIG. 2 is a schematic view showing a website presenting effect according to an embodiment of the disclosure. FIG. 2 is an example showing the tiled presenting effect, wherein the reference sign 1 represents the background image of the browser, and the reference sign 2 represents the background image of the presented website. As seen from FIG. 2, “1” and “2” use the same background image which is tiled on the browser and the presented website page, so that the styles of the website and of the browser are consistent with each other.

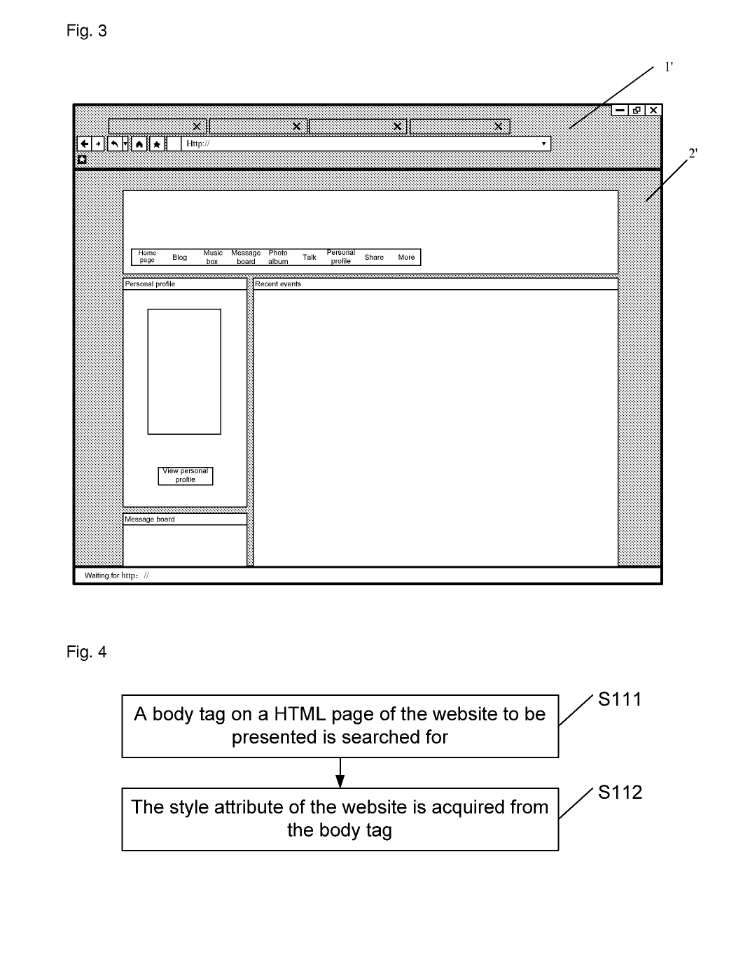

FIG. 3 is another schematic view showing a website presenting effect according to an embodiment of the disclosure. FIG. 3 is an example showing the tone presenting effect, wherein the reference sign 1′ represents the background color of the browser (such as light blue), and the reference sign 2′ represents the background color of the presented website (such as light blue). As seen from FIG. 3, “1′” and “2′” use the same background color, so that the user may see the integrated styles of the website and the browser when browsing the website, so as to gain a more novel and comfortable browsing experience.

It should be noted that the website presenting effects according to the embodiments of the disclosure are not limited to the examples in FIGS. 2 and 3 and may also be a title presenting effect. Specifically, an image same as or similar to the background image of the website or a color same as or similar to the background color of the website may be used only at the top of the browser, so that the styles of the website and of the browser are integrated into a whole. The website presenting effect may further be a stretched presenting effect. Specifically, the background images of the browser and of the website may be completely joined together to make the whole background an integrated image.

FIG. 4 is a flow chart of an embodiment of Step S101 as shown in FIG. 1. Referring to FIG. 4, in this embodiment, Step S101 may include:

S111: the body tag of the HTML page of a website to be presented is searched for.

The style attribute of the website may be set in the attribute of the body tag of the HTML page of the website, and thus in Step S111, a server of the website is searched for the body tag of the HTML page of the website.

S112: a Javascript is executed to acquire the style attribute of the website from the body tag.

In Step S112, the Javascript may be executed in the browser to acquire the style attribute of the website from the attribute of the body tag. The code for acquiring the style attribute of the website may be as follows:

var bgImage=document.body.style.backgroundImage;// acquiring the background image of a page

var bgColor=document.body.style.backgroundColor;// acquiring the background color of a page.

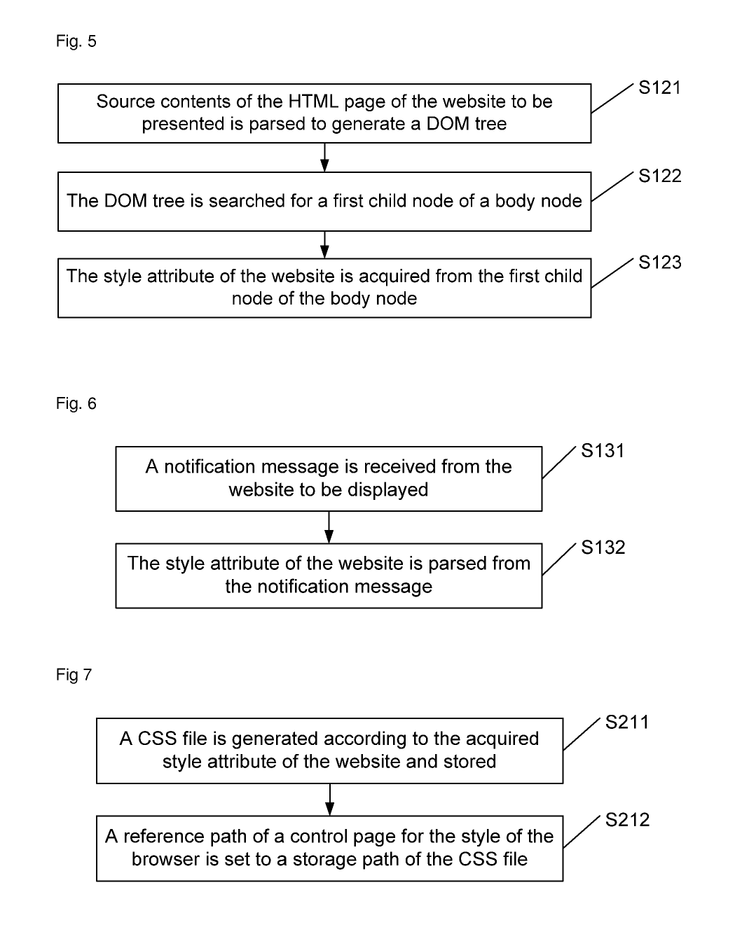

FIG. 5 is a flow chart of another embodiment of Step S101 as shown in FIG. 1. Referring to FIG. 5, in this embodiment, Step S101 may include:

S121: the source contents of the HTML page of the website to be presented is parsed to generate a Document Object Model (DOM) tree.

The DOM tree includes nodes of the HTML page and the attribute of each node. The source contents of the HTML page of the website to be presented may include: various tags on the HTML page and the attributes of various tags (such as the name and path of a tag and the text content information included in the tag). When the user visits the website with the browser, the server, in which the website to be presented is located, may return the source contents of the HTML page of the website to the browser. In Step S121, the browser parses the source contents of the HTML page, converts them into the DOM tree, which maps the whole page to a tree data structure consisting of hierarchical nodes. Since the nodes in the DOM tree are converted from the tags on the HTML page, they are referred to as page nodes and correspond to the tags on the HTML page one to one.

S122: the DOM tree is searched for the first child node of the body node.

In Step S122, the generated DOM tree is searched for the body node (i.e., the node in the DOM tree corresponding to the body tag of the HTML page of the website), and the first child node of the body node is further searched for.

S123: a Javascript is executed to acquire the style attribute of the website from the first child node of the body node.

Generally, the first child node of the body node contains almost all style attributes of the website and other child nodes of the body node may contain a portion of style attributes of the website. In Step S123, the Javascript may be executed in the browser to acquire almost all the style attributes of the website from the first child node of the body node. As understood, in Step S123, the Javascript may also acquire style attributes of the website from other child nodes of the body node. The code for acquiring style attributes of the website may be as follows:

var bgImage=document.body.style.backgroundImage;// acquiring the background image of a page

var bgColor=document.body.style.backgroundColor;// acquiring the background color of a page.

FIG. 6 is a flow chart of another embodiment of Step S101 as shown in FIG. 1. Referring to FIG. 6, in this embodiment, Step S101 may include:

S131: a notification message is received from the website to be presented.

The browser may provide the website with at least one Application Programming Interface (API), such as a callback interface, to enable the Javascript on the website to call the API to send to the browser a notification message, which may include the style attribute of the website. In Step S131, the browser receives the notification message from the website to be presented. For example, if the background color of the website is gray, the Javascript code of the website for calling the API to send the notification message may be as follows:

qqbrowserskin.setStyle(‘gray’);// the website notifies the browser to set a gray-background style.

S132: the style attribute of the website is parsed from the notification message.

It should be noted that the notification message may further include the style attribute of the browser to be set, for example, the website may determine a style attribute similar to its own style attribute according to its own style attribute and send the similar style attribute to the browser through the notification message, so that the browser may set the similar style attribute.

FIG. 7 is a flow chart of another embodiment of Step S102 as shown in FIG. 1. Referring to FIG. 7, in this embodiment, Step S102 may include:

S211: a CSS file is generated according to the acquired style attribute of the website, and stored.

In Step S211, the browser generates, according to the acquired style attribute of the website, a corresponding CSS file and stores the CSS file in the browser.

S212: the reference path of the control page for the style of the browser is set to the storage path of the CSS file.

The style of the browser may be controlled through an HTML page, and the control page corresponds to one CSS file. That is, the control page references its corresponding CSS file path. In Step S212, the CSS file path currently referenced by the control page may be replaced with the CSS file path corresponding to the new style stored in Step S211. That is, the CSS file corresponding to the control page may be changed to change the style of the browser.

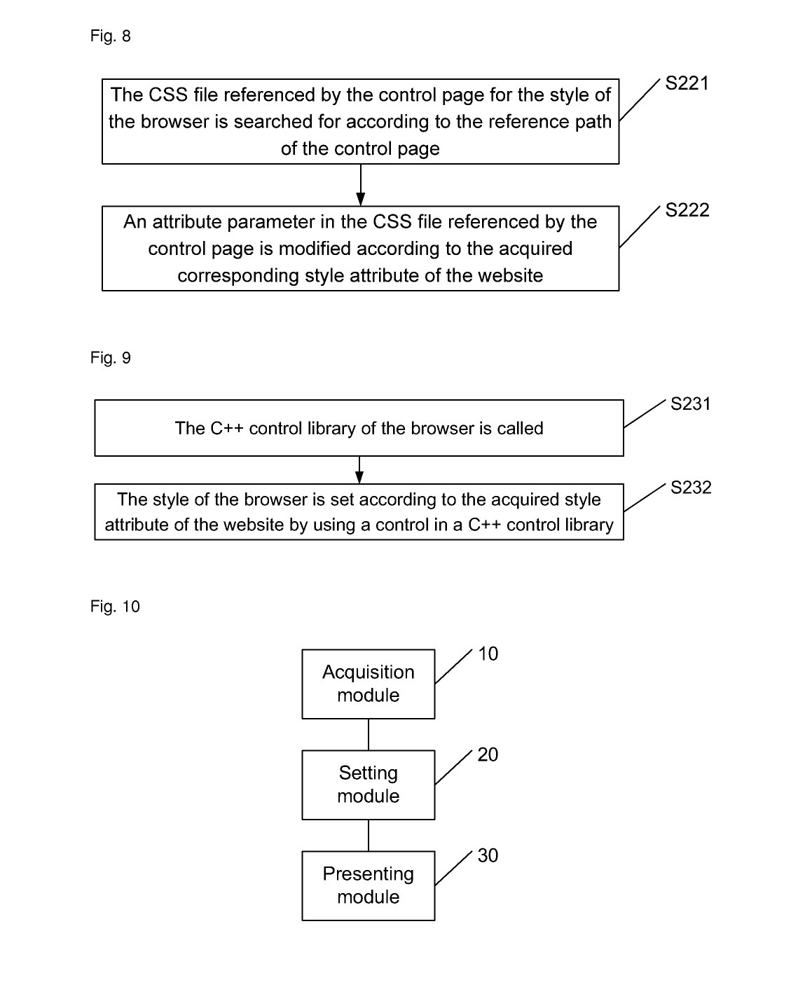

FIG. 8 is a flow chart of another embodiment of Step S102 as shown in FIG. 1. Referring to FIG. 8, in this embodiment, Step S102 may include:

S221: the CSS file referenced by the control page is searched for according to the reference path of the control page for the style of the browser.

The style of the browser may be controlled through an HTML page, and the control page corresponds to one CSS file. That is, the control page references its corresponding CSS file path. In Step S221, the CSS file corresponding to the control page may be searched for according to the CSS file path.

S222: according to the acquired style attribute of the website, the corresponding attribute parameter in the CSS file referenced by the control page is modified. In Step S222, the corresponding attribute parameter may be modified in the CSS file searched out according to the acquired style attribute of the website, so as to set the style attribute of the browser to be the same as or similar to the style attribute of the website.

FIG. 9 is a flow chart of another embodiment of Step S102 as shown in FIG. 1. Referring to FIG. 9, in this embodiment, Step S102 may include:

S231: the C++ control library of the browser is called.

The browser itself has a C++ control library which provides a visual operation environment; and the style of the browser may be set in a visual interface by using the C++ control library. The C++ control library of the browser is called in Step S231.

S232: the style of the browser is set according to the acquired style attribute of the website by using the control in the C++ control library.

In Step S232, the browser may set its style in a visual window to be the same as or similar to the style attribute of the website by using the control in the C++ control library.

In the embodiments of the disclosure, the style attribute of the website to be presented is acquired and the style attribute of the browser is set according to the style attribute of the website, so that the styles of the website and of the browser are consistent with each other. The browser is controlled to present the website according to the set style, such that consistent styles may result in a good visual effect, and accordingly, the user may gain a more novel and comfortable browsing experience.

In the embodiment, when the website is being visited with the browser, the browser is presented in a style which is the same as or similar to the style of the website to be presented. It should be noted that, if the website in the browser is shut down, the browser may maintain the current style or recover its previous style or recover its default style.

The browser according to the embodiment of the disclosure, corresponding to the website presenting method according to the embodiment of the disclosure with reference to FIGS. 1 to 9, is described below in detail with reference to FIGS. 10 to 16. The browser may be applied to the above described website presenting method according to the embodiment of the disclosure.

FIG. 10 is a diagram showing the structure of a browser according to an embodiment of the disclosure. Referring to FIG. 10, the browser may include an acquisition module 10, a setting module 20 and a presenting module 30.

The acquisition module 10 is configured to acquire the style attribute of the website to be presented.

When a user visits the website with the browser, the acquisition module 10 acquires the style attribute of the website to be presented. The style attribute of the website may be set in the HTML page of the website, and the acquisition module 10 may parse the HTML page to acquire the style attribute of the website. The style attribute of the website may also be set in the attribute of the body tag of the HTML page of the website. In this case, the acquisition module 10 may also acquire the style attribute of the website directly from the attribute of the body tag of the HTML page. The acquisition module 10 may further receive a notification message from the website, so as to acquire the style attribute of the website from the notification message. As understood, the acquisition module 10 may further acquire the style attribute of the website to be presented in other ways. For example, the acquisition module 10 may acquire the style attribute of the website by detecting the URL of the website, the HTTP header, the Cookies of the website or the like.

The setting module 20 is configured to set the style attribute of the browser according to the style attribute of the website acquired by the acquisition module 10.

The setting module 20 may set the style attribute of the browser by using a control page or a C++ control library of the browser. In practice, the setting module 20 may set the style attribute of the browser to be the same as or similar to the acquired style attribute of the website, wherein an attribute range may be preset for the website as being similar to the style of the website, for example, a color value range may be preset for the website as being similar to the background color of the website. The setting module 20 may set the style attribute of the browser to be similar to the acquired attribute of the website according to the range of similar attributes preset for the website.

The presenting module 30 is configured to control the browser to present the website according to the style set by the setting module 20.

The style attribute of the browser set by the setting module 20 is the same as or similar to the style attribute of the website to be presented, and the presenting module 30 may enable the browser to present the website according to the set style, so that the styles of the website and of the browser are consistent with each other when the website is presented, thereby resulting in a good visual effect. In practice, the effect of presenting the website by the presenting module 30 is as shown in FIGS. 2 and 3, and thus the description thereof is omitted here.

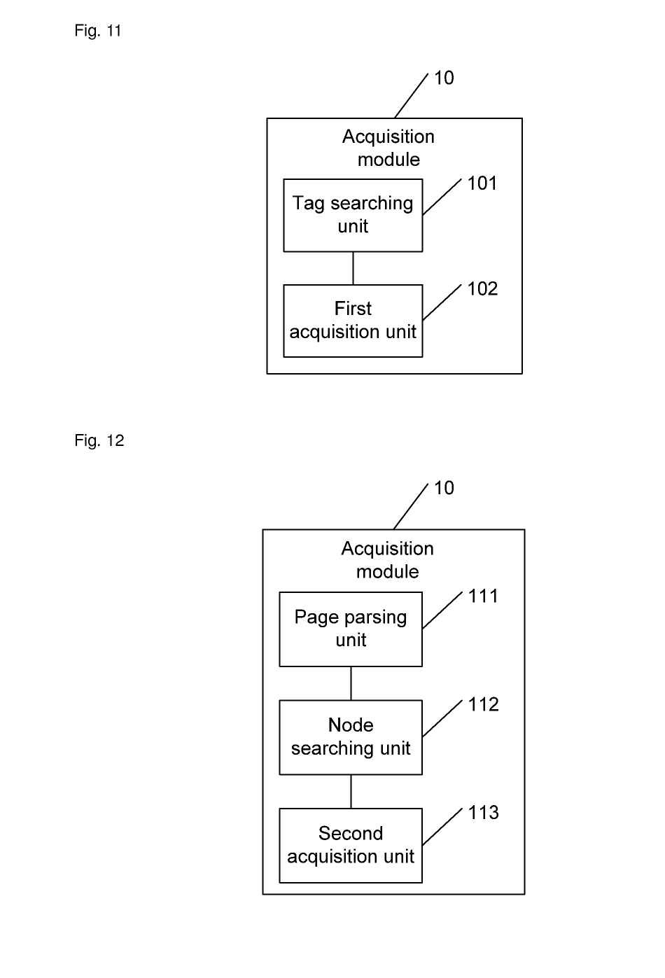

FIG. 11 is a diagram showing the structure of an embodiment of the acquisition module as shown in FIG. 10. Referring to FIG. 11, in this embodiment, the acquisition module 10 may include a tag searching unit 101 and a first acquisition unit 102.

The tag searching unit 101 is configured to search for the body tag of the HTML page of the website to be presented.

The style attribute of the website may be set in the attribute of the body tag of the HTML page of the website. In this case, the tag searching unit 101 may search the server of the website for the body tag of the HTML page of the website.

The first acquisition unit 102 is configured to execute a Javascript to acquire the style attribute of the website from the body tag searched out the tag searching unit 101.

The first acquisition unit 102 may execute the Javascript to acquire the style attribute of the website from the attribute of the body tag. The code for acquiring style attributes of the website may be as follows:

var bgImage=document.body.style.backgroundImage; // acquiring the background image of a page

var bgColor=document.body.style.backgroundColor; // acquiring the background color of a page.

FIG. 12 is a diagram showing the structure of an embodiment of the acquisition module as shown in FIG. 10. Referring to FIG. 12, in this embodiment, the acquisition module 10 may include a page parsing unit 111, a node searching unit 112 and a second acquisition unit 113.

The page parsing unit 111 is configured to parse the source contents of the HTML page of the website to be presented to generate a DOM tree.

The DOM tree includes the nodes of the HTML page and the attribute of each node. The source contents of the HTML page of the website to be presented may include: various tags on the HTML page and the attributes of various tags (such as the name and path of a tag and the text content information included in the tag). When the user visits the website with the browser, the server, in which the website to be presented is located, may return the source contents of the HTML page of the website to the browser. The page parsing unit 111 parses the source contents of the HTML page, converts them into the DOM tree, which maps the whole page to a tree data structure consisting of hierarchical nodes. Since the nodes in the DOM tree are converted from the tags on the HTML page, they are referred to as page nodes and correspond to the tags on the HTML page one to one.

The node searching unit 112 is configured to search the DOM tree generated by the page parsing unit 111 for the first child node of the body node.

The node searching unit 112 may search the generated DOM tree for the body node (i.e., the node in the DOM tree corresponding to the body tag on the HTML page of the website), and further search for the first child node of the body node.

The second acquisition unit 113 is configured to execute a Javascript to acquire the style attribute of the website from the first child node of the body node searched out by the node searching unit 112.

Generally, the first child node of the body node contains almost all style attributes of the website and other child nodes of the body node may contain a portion of style attributes of the website. The second acquisition unit 113 may execute the Javascript to acquire almost all the style attributes of the website from the first child node of the body node. As understood, the second acquisition unit 113 may also acquire the style attribute of the website from other child nodes of the body node. The code for acquiring style attributes of the website may be as follows:

var bglmage=document.body.style.backgroundImage; // acquiring the background image of a page

var bgColor=document.body.style.backgroundColor; // acquiring the background color of a page.

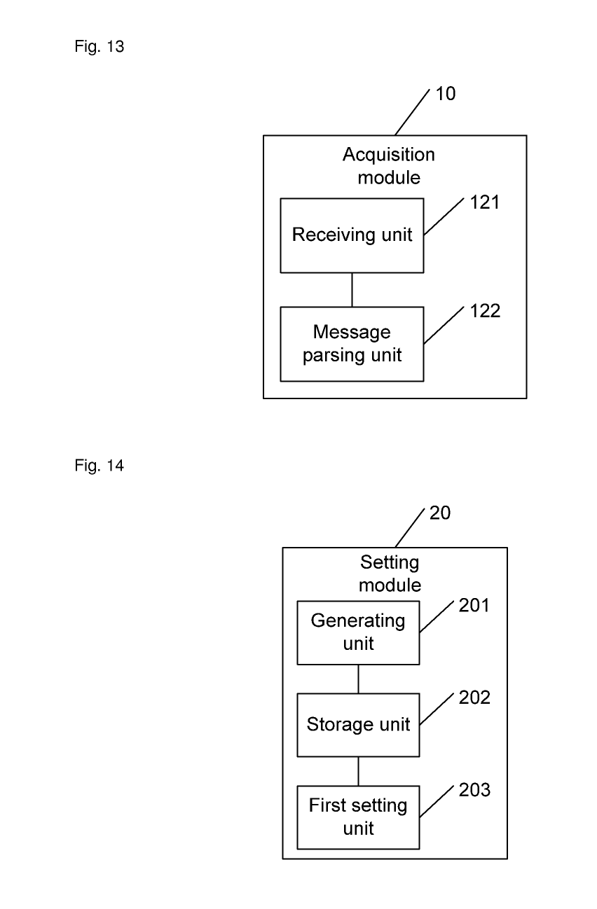

FIG. 13 is a diagram showing the structure of an embodiment of the acquisition module as shown in FIG. 10. Referring to FIG. 13, in this embodiment, the acquisition module 10 may include a receiving unit 121 and a message parsing unit 122.

The receiving unit 121 is configured to receive a notification message from the website to be presented.

The browser may provide the website with at least one API, such as a callback interface, to enable the Javascript on the website to call the API to send to the browser a notification message, which may include the style attribute of the website. The receiving unit 121 receives the notification message from the website to be presented. For example, if the background color of the website is gray, the Javascript code of the website for calling the API to send the notification message may be as follows:

qqbrowser.skin.setStyle(‘gray’); // the website notifies the browser to set a gray-background style.

The message parsing unit 122 is configured to parse the style attribute of the website from the notification message received by the receiving unit 121.

It should be noted that the notification message may further include the style attribute of the browser to be set, for example, the website may determine a style attribute similar to its own style attribute according to its own style attribute and send the similar style attribute to the browser through the notification message, so that the browser may set the similar style attribute.

FIG. 14 is a diagram showing the structure of an embodiment of the setting module as shown in FIG. 10. Referring to FIG. 14, in this embodiment, the setting module 20 may include a generating unit 201, a storage unit 202 and a first setting unit 203.

The generating unit 201 is configured to generate a CSS file according to the acquired style attribute of the website.

The storage unit 202 is configured to store the CSS file acquired from the generating unit 201; and

The first setting unit 203 is configured to set the reference path of the control page for the style of the browser to the storage path of the CSS file stored by the storage unit 202.

The style of the browser may be controlled through an HTML page, and the control page corresponds to one CSS file. That is, the control page references its corresponding CSS file path. The first setting unit 203 may replace the CSS file path currently referenced by the control page with the CSS file path corresponding to a new style stored by the storage unit 202. That is, the CSS file corresponding to the control page may be changed to change the style of the browser.

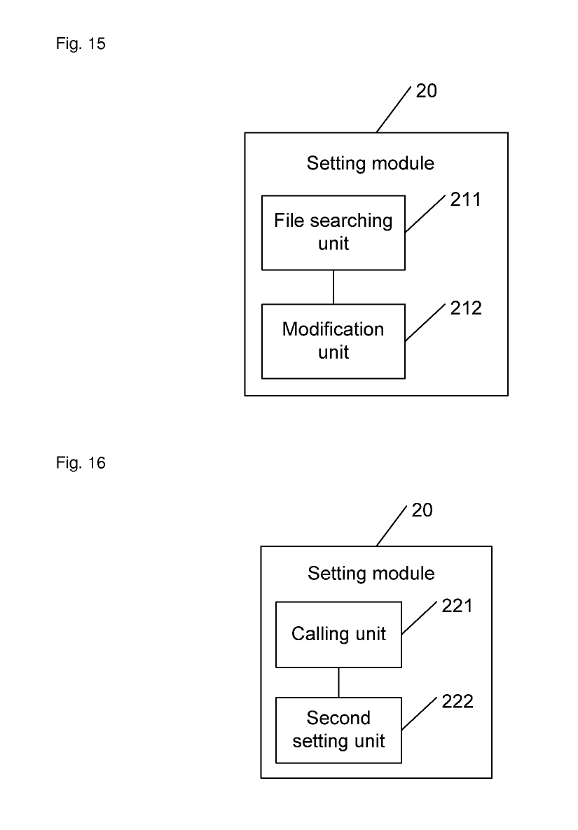

FIG. 15 is a diagram showing the structure of an embodiment of the setting module as shown in FIG. 10. Referring to FIG. 15, in this embodiment, the setting module 20 may include a file searching unit 211 and a modification unit 212.

The file searching unit 211 is configured to search for the CSS file referenced by the control page according to the reference path of the control page for the style of the browser.

The style of the browser may be controlled through an HTML page, and the control page corresponds to one CSS file. That is, the control page references its corresponding CSS file path. The file searching unit 211 may search for the CSS file corresponding to the control page according to the CSS file path.

The modification unit 212 is configured to modify, according to the style attribute of the website acquired by the acquisition module 10, the corresponding attribute parameter in the CSS file searched out by the file searching unit.

The modification unit 212 may modify, according to the acquired style attribute of the website, the corresponding attribute parameter in the CSS file searched out, to set the style attribute of the browser to be the same as or similar to the style attribute of the website.

FIG. 16 is a diagram showing the structure of an embodiment of the setting module as shown in FIG. 10. Referring to FIG. 16, in this embodiment, the setting module 20 may include a calling unit 221 and a second setting unit 222.

The calling unit 221 is configured to call the C++ control library of the browser.

The browser itself has a C++ control library which provides a visual operation environment; and the style of the browser may be set in a visual interface by using the C++ control library. The calling unit 221 may call the C++ control library of the browser.

The second setting unit 222 is configured to set the style of the browser by using the control in the C++ control library called by the calling unit 221, according to the style attribute of the website acquired by the acquisition module 10.

The second setting unit 222 may set the style attribute of the browser to be the same as or similar to that of the website in a visual window by using the control in the C++ control library called by the calling unit 221.

In the embodiments of the disclosure, the style attribute of the website to be presented is acquired and the style attribute of the browser is set according to the style attribute of the website, so that the styles of the website and of the browser are consistent with each other. The browser is controlled to present the website according to the set style, such that consistent styles may result in a good visual effect, and accordingly, the user may gain a more novel and comfortable browsing experience.

Persons of ordinary skill in the art may understand that all or some of the processes in the method embodiments above may be implemented through instructing related hardware by a computer program. The program may be stored in a computer readable storage medium, which when executed, may include the processes of the method embodiments above. The storage medium may be diskette, compact disc, read-only memory (ROM) or random access memory (RAM), etc.

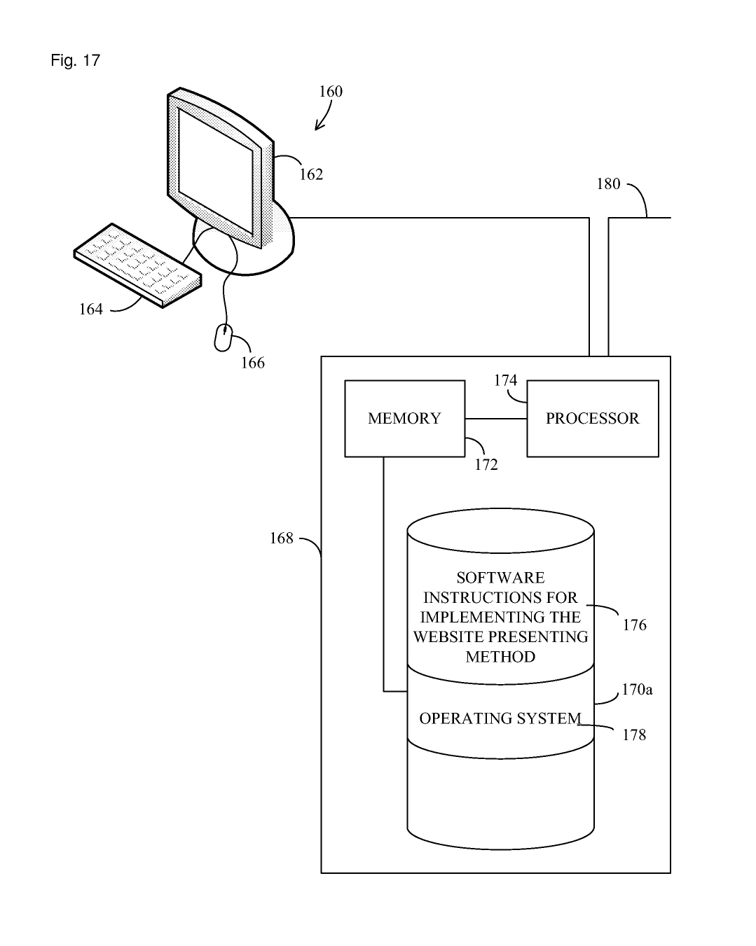

FIG. 17 is a diagram of any exemplary computer platform 160 on which the website presenting method or the browser described in connection with FIGS. 1-16 is implemented. As shown in FIG. 17, the computer platform includes a display 162, as keyboard 164, a pointing device 166 such as a mouse, and a digital computer 168. The digital computer 168 includes a memory 172, a processor 174, a mass storage device 170a and other customary components such as memory bus and peripheral bus (not shown). The platform 160 may further include a network connection 180.

Mass storage device 170a can store the instructions 176 for implementing the website presenting method or the browser over an operating system 178. The instructions 176 may be transferred to memory 172 and processor 174 in the course of operation. The instructions cause a website and the browser, of which styles are consistent with each other, to be displayed in display 162. The instructions 176 can be stored on a variety of mass storage devices, including semiconductor memory devices, such as EPROM, EEPROM and flash memory devices; magnetic devices, such as internal hard disks and removable disks; magneto-optical disks; and CD-ROM disks.

Any of the foregoing may be supplemented by, or implemented in, specifically-designed ASICs (application specific integrated circuits).

It should be noted that electronic devices suitable for implementing the website presenting method or the browser according to the disclosure is not limited to the computer platform 160 as shown in FIG. 17. The electronic devices may be of any type, such as computers (e.g. desktop, notebook, netbook, tablet) and mobile devices (e.g., mobile telephones, tablet computers, game consoles, personal digital assistants). In some implementations, the electronic devices are client devices that are connected to servers via a computer or communications network (e.g., a cellular network or the Internet). These client devices communicate with the servers through wired or wireless connections.

What are disclosed above are only preferred embodiments of the disclosure but not intended to limit the scope of the disclosure. Those skilled in the art may understand all or partial processes for implementing the embodiments above, and any equivalent modifications made according to the claims of the disclosure shall fall within the scope of the disclosure.

1. A website presenting method, comprising:
acquiring a style attribute of a website to be presented;
setting a style attribute of a browser according to the acquired style attribute of the website; and
presenting the website according to the set style attribute.

2. The method according to claim 1, wherein the acquiring the style attribute of the website to be presented comprises:
searching for a body tag on a HyperText Markup Language (HTML) page of the website to be presented; and
executing a Javascript to acquire the style attribute of the website from the body tag.

3. The method according to claim 1, wherein the acquiring the style attribute of the website to be presented comprises:
parsing source contents of a HTML page of the website to be presented to generate a Document Object Model (DOM) tree, which includes nodes of the HTML page and an attribute of each node;
searching the DOM tree for a first child node of a body node; and
executing a Javascript to acquire the style attribute of the website from the first child node of the body node.

4. The method according to claim 1, wherein the acquiring the style attribute of the website to be presented comprises:
receiving a notification message, which contains the style attribute of the website, from the website to be presented; and
parsing the style attribute of the website from the notification message,
wherein the website executes a Javascript to call an Application Programming Interface (API) of the browser to send the notification message.

5. The method according to claim 1, wherein the setting the style attribute of the browser according to the acquired style attribute of the website comprises:
generating a Cascading Style Sheet (CSS) file according to the acquired style attribute of the website and storing the CSS file; and
setting a reference path of a control page for the style of the browser to a storage path of the CSS file.

6. The method according to claim 1, wherein the setting the style attribute of the browser according to the acquired style attribute of the website comprises:
searching, according to a reference path of a control page for the style of the browser, for a CSS file referenced by the control page; and
modifying, according to the acquired style attribute of the website, a corresponding attribute parameter in the CSS file referenced by the control page.

7. The method according to claim 1, wherein the setting the style attribute of the browser according to the acquired style attribute comprises:
calling a C++ control library of the browser; and
setting, according to the acquired style attribute of the website, the style of the browser by using a control in the C++ control library.

8. A browser, comprising:
an acquisition module, configured to acquire a style attribute of a website to be presented;
a setting module, configured to set a style attribute of the browser according to the style attribute of the website acquired by the acquisition module; and
a presenting module, configured to control the browser to present the website according to the style set by the setting module.

9. The browser according to claim 8, wherein the acquisition module comprises:
a tag searching unit, configured to search for a body tag on a HyperText Markup Language (HTML) page of the website to be presented; and
a first acquisition unit, configured to execute a Javascript to acquire the style attribute of the website from the body tag searched out by the tag searching unit.

10. The browser according to claim 8, wherein the acquisition module comprises:
a page parsing unit, configured to parse source contents of a HTML page of the website to be presented to generate a Document Object Model (DOM) tree, which includes nodes of the HTML page and an attribute of each node;
a node searching unit, configured to search the DOM tree generated by the page parsing unit for a first child node of a body node; and
a second acquisition unit, configured to execute a Javascript to acquire the style attribute of the website from the first child node of the body node searched out by the node searching unit.

11. The browser according to claim 8, wherein the acquisition module comprises:
a receiving unit, configured to receive a notification message, which contains the style attribute of the website, from the website to be presented; and
a message parsing unit, configured to parse the style attribute of the website from the notification message received by the receiving unit,
wherein the website executes a Javascript to call an Application Programming Interface (API) of the browser to send the notification message.

12. The browser according to claim 8, wherein the setting module comprises:
a generating unit, configured to generate a Cascading Style Sheet (CSS) file according to the acquired style attribute of the website;
a storage unit, configured to store the CSS file acquired by the generating unit; and
a first setting unit, configured to set a reference path of a control page for the style of the browser to a storage path of the CSS file stored by the storage unit.

13. The browser according to claim 8, wherein the setting module comprises:
a file searching unit, configured to search, according to a reference path of a control page for the style of the browser, for a CSS file referenced by the control page; and
a modification unit, configured to modify, according to the style attribute of the website acquired by the acquisition module, a corresponding attribute parameter in the CSS file searched out by the file searching unit.

14. The browser according to claim 8, wherein the setting module comprises:
a calling unit, configured to call a C++ control library of the browser; and
a second setting unit, configured to set, according to the style attribute of the website acquired by the acquisition module, the style of the browser by using a control in the C++ control library called by the calling unit.

15. A non-transitory computer-readable storage medium including a set of instructions that, when executed, cause at least one processor to:
acquire a style attribute of a website to be presented;
set a style attribute of a browser according to the acquired style attribute of the website; and
present the website according to the set style attribute.

16. The non-transitory computer-readable storage medium according to claim 15, wherein the instructions that, when executed, cause at least one processor to acquire the style attribute of the website to be presented comprises instructions that, when executed, cause at least one processor to
search for a body tag on a HyperText Markup Language (HTML) page of the website to be presented; and
execute a Javascript to acquire the style attribute of the website from the body tag.

17. The non-transitory computer-readable storage medium according to claim 15, wherein the instructions that, when executed, cause at least one processor to acquire the style attribute of the website to be presented comprises instructions that, when executed, cause at least one processor to
parse source contents of a HTML page of the website to be presented to generate a Document Object Model (DOM) tree, which includes nodes of the HTML page and an attribute of each node;
search the DOM tree for a first child node of a body node; and
execute a Javascript to acquire the style attribute of the website from the first child node of the body node.

18. The non-transitory computer-readable storage medium according to claim 15, wherein the instructions that, when executed, cause at least one processor to acquire the style attribute of the website to be presented comprises instructions that, when executed, cause at least one processor to
receive a notification message, which contains the style attribute of the website, from the website to be presented; and
parse the style attribute of the website from the notification message,
wherein the website executes a Javascript to call an Application Programming Interface (API) of the browser to send the notification message.

19. The non-transitory computer-readable storage medium according to claim 15, wherein the instructions that, when executed, cause at least one processor to set the style attribute of the browser according to the acquired style attribute of the website comprises instructions that, when executed, cause at least one processor to
generate a Cascading Style Sheet (CSS) file according to the acquired style attribute of the website and storing the CSS file; and
set a reference path of a control page for the style of the browser to a storage path of the CSS file.

20. The non-transitory computer-readable storage medium according to claim 15, wherein the instructions that, when executed, cause at least one processor to set the style attribute of the browser according to the acquired style attribute of the website comprises instructions that, when executed, cause at least one processor to
search, according to a reference path of a control page for the style of the browser, for a CSS file referenced by the control page; and
modify, according to the acquired style attribute of the website, a corresponding attribute parameter in the CSS file referenced by the control page.
